(19) United States
(12) Patent Application Publication
(10) Pub. No.: US 2024/0294145 A1
(43) Pub. Date: Sep. 5, 2024

(54) METHOD FOR CHECKING THE OPERATION OF A VEHICLE SURFACE CLEANING DEVICE

(71) Applicant: VALEO SYSTEMES D'ESSUYAGE, La Verriere (FR)

(72) Inventor: Giuseppe GRASSO, La Verriere (FR)

(73) Assignee: VALEO SYSTEMES D'ESSUYAGE, La Verriere (FR)

(21) Appl. No.: 18/261,701

(22) PCT Filed: Nov. 29, 2021
(86) PCT No.: PCT/EP2021/083399

§ 371 Date: Jul. 17, 2023

(30) Foreign Application Priority Data
Jan. 26, 2021 (FR) 2100703

(51) Int. Cl. B60S 1/48; B60S 1/56

(52) U.S. Cl. CPC B60S 1/481; B60S 1/56

(57) ABSTRACT

A method for verifying the operation of a cleaning device mounted on a motor vehicle, comprising at least one of the following steps: commanding a pump to inject cleaning fluid as far as at least one valve during a determined time period, the command to activate the pump being coupled with the keeping of the valve or valves in the closed state; at least one measurement of a parameter relating to the pressure of the cleaning liquid upstream of the valve or valves using at least one pressure sensor; comparing the measured parameter relating to the pressure against a predetermined expected value; and determining an operating status of the cleaning device on the basis of the result of the comparison between the measured parameter relating to the pressure and the predetermined expected value; and generating a warning signal in the event that the cleaning device is malfunctioning.

### TECHNICAL FIELD

The invention relates to devices for cleaning a surface of a motor vehicle and which are intended to be carried on board a motor vehicle.

### BACKGROUND OF THE INVENTION

Numerous surfaces, for example driver assist sensors of motor vehicles, may be subjected to various types of dirtiness. These sensors include for example the various cameras or the distance sensors, ultrasonic sensors, radars, LIDAR sensors or rain sensors placed on the vehicle.

Now, this dirtiness may cause certain driver assist devices to malfunction or cause a user of the vehicle to begin to experience difficulties (lack of visibility because of dirt on the windshield). It is therefore necessary to provide at least a device for cleaning these surfaces

Conventionally, such cleaning devices comprise a reservoir in which cleaning liquid is stored, and a fluid distribution circuit made up of various pipes or tubes that make it possible to convey the cleaning liquid to at least one cleaning nozzle placed in front of a surface so as to spray cleaning liquid onto it (as a general rule, there are a plurality of cleaning nozzles for a plurality of surfaces).

A pump intended to propel the cleaning liquid in the fluid distribution circuit as far as the cleaning nozzle is generally mounted directly on the reservoir. More specifically, a liquid intake tube of the pump is forced-fitted into an opening made in the reservoir (a seal is used to ensure that the assembly is leak-tight), and the liquid discharge orifice is connected to the fluid distribution circuit.

It is also known practice to position, on the fluid distribution circuit, a cleaning-liquid distribution block comprising for example several valves between the pump and the cleaning nozzle or nozzles, it being possible for each valve to be fluidically connected to one or more cleaning nozzles. This valve block allows, for example, the valves to be opened selectively so that cleaning liquid is sprayed only through those cleaning nozzles that are situated facing a surface that needs to be cleaned, while the other cleaning nozzles are kept inactive. It is also possible to use the distribution block as an intermediate stage level enabling maximum pressurization of part of the fluid distribution circuit situated between the pump and the distribution block so as to limit pressure drops as far as the cleaning nozzles.

When the malfunctioning of a driver assist sensor due to the presence of dirt is detected (automatically, for example), or when the user activates a cleaning command, the pump draws cleaning liquid from the reservoir, the liquid being at a similar pressure to atmospheric pressure (the pressure depends on the height of cleaning liquid in the reservoir), and propels it into the fluid distribution circuit at a higher pressure (the pressure difference depends on the capacity of the pump). The pressurized cleaning liquid passes through one or more of the valves in the open position and is sprayed by the cleaning nozzle or nozzles onto one or more sensors (or some other surface that is to be cleaned).

### SUMMARY OF THE INVENTION

As explained previously, the cleaning device makes it possible to ensure the cleanliness of sensors that may be crucial for a user of the vehicle, thus in part ensuring that they are properly operational. It is therefore necessary to be able to verify proper operation of the cleaning device so as to avoid this not being achieved until after one or more sensors have failed to operate properly. This becomes all the more crucial in the case of self-driving motor vehicles. Specifically, it could make it possible to alert a user of the vehicle while at the same time, if possible, switching the operation of the cleaning device or of the sensors into a downgraded mode. Defective operation may for example arise from a fault with the pump (pump no longer operating or operating poorly), with the pipes (for example punctured) or else with the liquid distribution block (complete or partial failure of one or more valves to open or to close).

It is a notable objective of the invention to provide a method for verifying the operation of a device for cleaning a surface of a vehicle so as to ensure that the cleaning device is operating properly and thus, where applicable, anticipate defective operation of driver assist sensors present on the motor vehicle.

To that end, one subject of the invention is a method for verifying the operation of a vehicle-surface cleaning device intended to be mounted on a motor vehicle, the cleaning device comprising a reservoir with cleaning liquid, at least one nozzle for spraying the cleaning liquid onto a surface that is to be cleaned, a fluid distribution circuit designed to convey the cleaning liquid from the reservoir to the cleaning nozzle and a pump designed to inject the cleaning liquid contained in the reservoir into the fluid distribution circuit, the fluid distribution circuit comprising a cleaning liquid distribution block comprising at least one valve and positioned between an outlet orifice of the pump and the nozzle, the method comprising, at least once, the following steps:
command to activate the pump to inject cleaning fluid as far as the valve during a determined time period, the command to activate the pump to inject liquid as far as an inlet orifice of the valve being coupled with the keeping of the valve or valves in the closed state,
at least one measurement of a parameter relating to the pressure of the cleaning liquid in a segment of the fluid distribution circuit located upstream of the valve or valves using at least one pressure sensor,
comparison of the measured pressure parameter against a predetermined expected value, and
determination of an operating status of the cleaning device on the basis of the result of the comparison between the measured parameter relating to the pressure and the predetermined expected value, and
generation of a warning signal in the event that the cleaning device is malfunctioning.

Thus, what is obtained is a method that makes it possible to ensure that the pump and the liquid distribution block are operating properly.

Specifically, by pressurizing the segment of the fluid distribution circuit that is located between the outlet orifice of the pump and the valve (i.e. by activating the pump and closing the valve or valves of the liquid distribution block), it is possible for example to measure whether the pressure attained is indeed as expected If it is not, then the cleaning device has a fault, potentially with the pump (incapable of sufficiently pressurizing the segment concerned) or with the distribution block (comprising at least one valve that is not fully closed causing a leak to appear).

The pressure may also be measured after pressurization and opening of the at least one valve of the distribution block so as to ensure that the pressure decreases to an expected level. A failure of the pressure to decrease or too slow a decrease in pressure would make it possible to conclude that there is a fault with the opening, partial or full, of at least one valve of the distribution block.

According to further optional features of the cleaning system, taken individually or in combination:
The duration between the command to activate the pump while keeping the valve or valves in the closed state may be greater than or equal to a duration enabling a maximum pressure to be attained in the segment of the fluid distribution circuit that is located between the outlet orifice of the pump and the valve in normal operation;
The method steps may for example take place upon the starting of the engine of the motor vehicle. In that case, a verification is made as early on as possible in order to quickly ensure that the cleaning device is operating properly or to quickly identify a malfunction;
The method steps may for example take place at least once during a cycle of cleaning at least one surface of the motor vehicle. This then takes advantage of the necessary activation of the cleaning device in order to take one or more measurements to verify that it is operating properly;
The measuring of the parameter relating to the pressure in the segment of the fluid distribution circuit that is located upstream of the valve or valves takes place for example prior to the first opening of a valve or between two openings of a valve. These are other possibilities for measuring values which in this instance reflect increases in pressure;
The command to activate the pump to inject liquid as far as an inlet orifice of the valve is followed by an opening of the valve for the duration of a determined period, the opening of the valve preceding a measurement of the parameter relating to the pressure in the segment of the fluid distribution circuit that is located upstream of the valve or valves. This is another possibility for measuring values which in this instance reflect decreases in pressure;
The opening of the valve notably takes place after the pressure in the segment of the fluid distribution circuit located upstream of the valve or valves has for example reached a maximum value. This then limits the pressure drops in the fluid distribution circuit by creating a pressurization stage level;
The predetermined expected value corresponds to a pressure lower than the pressure in the segment of the fluid distribution circuit located upstream of the valve or valves prior to the opening of the valve. This then is a concrete embodiment of the measurement of an expected pressure decrease following the opening of the valve;
the pressure sensor is, in particular, connected to the segment of the fluid distribution circuit that is located upstream of the valve or valves;
The cleaning device notably comprises an electronic control unit connected to the pressure sensor, to the pump and to the valve so as to control the activation of the pump, the opening and closing of the valve and the measuring of a parameter related to the pressure;
The cleaning device further comprises, for example, at least a flow sensor, the verification method comprising, at least once, the following steps:
command to activate the pump to inject liquid as far as the valve during a determined time period,
measurement of at least one flow rate of cleaning liquid,
comparison of the measured flow rate against a predetermined expected flow rate, and
determination of an operating status of the cleaning device.

This then is an additional measurement making it possible to check that the cleaning device is operating properly;
A flow sensor may be connected to the pump so as to measure the flow rate of liquid leaving the pump;
The distribution block comprises a valve, a flow sensor being for example connected to the valve so as to measure the flow rate of liquid leaving the valve, or
the distribution block comprises several valves, at least one flow sensor being connected to all the valves or to some of the valves so as to measure the flow rate of liquid leaving the valve.

These then are two alternative sittings of the flow sensor or sensors; and
The verification method comprising, at least once, the following steps:
command to activate the pump to inject liquid as far as the valve during a determined time period,
measurement of the electrical power consumption of the pump,
comparison of the electrical power consumption of the pump against a predetermined expected draw of current, and
determination of an operating status of the cleaning device.

This, once again, is an additional measurement making it possible to check that the cleaning device is operating properly.

### BRIEF DESCRIPTION OF THE DRAWINGS

The invention will be better understood on reading the following description, provided purely by way of example and with reference to the appended drawings, in which:

FIG. 1 is a schematic representation of a cleaning device according to the invention,

FIG. 2 is a depiction, in the form of a graph, of two normal modes of operation of a cleaning device according to the invention,

FIG. 3 is a depiction, in the form of a graph, of three defective modes of operation of a cleaning device according to the invention, and

FIG. 4 is a flow diagram of the various steps in the method according to the invention.

### DETAILED DESCRIPTION OF THE INVENTION

The embodiments described with reference to the figures are examples. Although the description refers to one or more embodiments, this does not necessarily mean that each reference relates to the same embodiment, or that the features apply only to one single embodiment. Individual features of various embodiments may also be combined to create other embodiments.

The terms “upstream” and “downstream” are used to locate the elements/devices in the direction in which the stream of substance to be handled is being transported. A first device or element, for example a pump, is thus situated upstream of a second device or element if the substance is handled first by the first device and then by the second device.

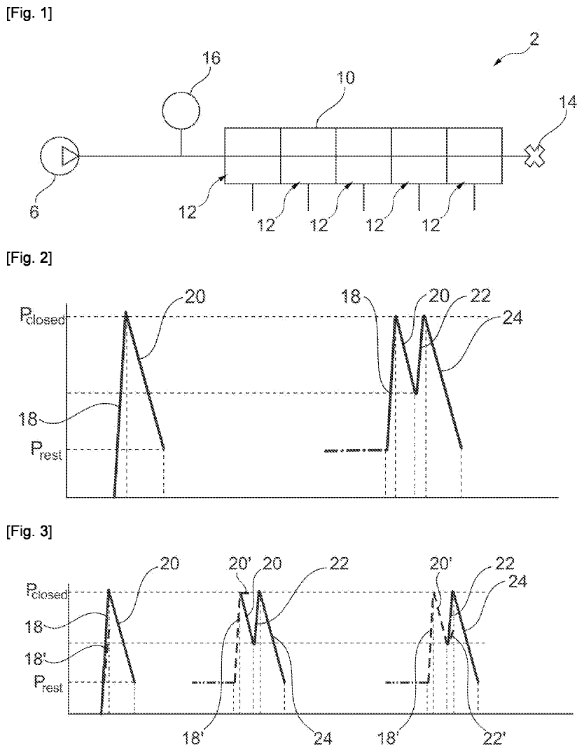

Reference is now made to FIG. 1, which shows a cleaning system 2 carried on board a motor vehicle. The aim of this cleaning system 2 is to make it possible to clean various surfaces of the motor vehicle such as, for example, sensors carried on board the vehicle, or the windshield or rear window.

The cleaning device comprises a cleaning liquid reservoir (not depicted in the figures) on which a pump 6 is mounted. The pump 6 is mounted in a recess of the reservoir intended for accommodating the pump 6, the reservoir comprising an orifice through which an intake tube of the pump 6 is mounted, with a seal at the interface between the reservoir and the pump 6 around the orifice in order to ensure that the assembly is leak-tight. As is conventional, the pump 6 is a standard pump comprising a tubular main body for example. This main body can be made up of a pumping first portion and a driving second portion comprising an electric motor. The pumping first portion comprises a liquid intake tube and a liquid discharge tube so that it can receive cleaning liquid from the reservoir and discharge it at a higher pressure than the intake pressure of the pump 6. The liquid intake tube can be placed at a free end of the pumping first portion and be coaxial with the main body of the pump 6, sharing the same axis of revolution as it. The discharging second portion can extend from the pumping first portion in a direction perpendicular to the axis of revolution of the main body.

By contrast, it may be that the pump 6 is mounted independently of the reservoir, for example on the structure of the vehicle, between the reservoir and the solenoid valves, as in a variant embodiment which has not been illustrated. In such a configuration, a first pipe is provided between the reservoir and the pump, and a second pipe is provided between the pump and the solenoid valves. Such configurations are particularly commonplace in trucks and other heavy vehicles.

The driving second portion can be situated above the pumping first portion and comprise an electric motor and, at its free end, a connector making it possible to connect the pump 6 to an electrical power source.

One or more cleaning nozzles (not shown in the figures) are situated at the other end of the cleaning device and are intended to be placed in front of a surface of the motor vehicle to be cleaned in order to spray pressurized cleaning liquid onto it.

The cleaning device further comprises pipes (or piping) connecting the different members (pump 6, cleaning nozzle, etc.) to each other to form a fluid distribution circuit 8.

The cleaning device 2 further comprises a cleaning liquid distribution block 10 comprising at least one valve 12 (five in this instance). The pump 6 is configured to pump the washing liquid from the tank and send it to the distribution block 10 and the spray nozzles.

The valves 12 of the distribution block 10 are configured to be fluidically connected respectively to the nozzles (a valve 12 connected to a nozzle for example, it being possible for the number of valves and of nozzles to vary). The valves 12 are configured to selectively transmit the pumped washing liquid to the associated cleaning nozzles. The valves 12 are, for example, solenoid valves conventionally used in this type of cleaning device. The valves 12 may be arranged in parallel, meaning that they are all connected to one fluidic channel of the distribution block 10. This fluidic channel is connected to an inlet 10a of the distribution block 10, which inlet is connected to the pump 6. An outlet 10b of the distribution block 10 is itself blanked off by a cap 14.

Thus, in operation, the activation of the pump 6 makes it possible to transmit the washing liquid from the tank toward the distribution block 10 and toward the cleaning nozzles the associated valve 12 of which is open.

The distribution block 10 is a modular block and so the number of solenoid valves 12 can easily be modified to adapt it to suit the number of cleaning nozzles, or to suit a particular configuration of the cleaning device, for example depending on the model of the motor vehicle if the cleaning device 2 is mounted on a motor vehicle. Different distribution blocks 10 can also be combined.

The cleaning device 2 finally comprises at least one pressure sensor 16 allowing measurement of a parameter relating to the pressure in a segment between an outlet orifice of the pump 6 and an inlet orifice of the valve or valves 12 (corresponding to the inlet 10a of the distribution block). This then is the segment, as may have been stated elsewhere in this document, situated upstream of the valve or valves. The pressure sensor 16 may be connected to the segment of the fluid distribution circuit that is located between the outlet orifice of the pump 6 and the valve or valves 12.

As regards the verification method, the first step thereof corresponds to a command to activate the pump to inject cleaning liquid as far as the valve during a determined time period, the command to activate the pump to inject liquid as far as an inlet orifice of the valve being coupled with the keeping of the valve in the closed state.

This step constitutes a pressurizing of the system and makes it possible, subsequently, to determine whether an upper-limit value has been attained or else whether this value has varied.

The second step consists in at least one measurement of a parameter relating to the pressure of the cleaning liquid in a segment of the fluid distribution circuit located between the outlet orifice of the pump and the valve using at least one pressure sensor.

This step then makes it possible to obtain, at least once, a value for a parameter relating to the pressure after the pressurization step. As will be seen later, this can be done directly after the pressurizing of the segment of the fluid distribution circuit 8 that is situated between the pump 6 and the distribution block 10 and/or after an opening and/or a closing of at least one valve 12 (various possibilities that can be combined with one another will be described later on).

Regarding the parameter measured, this may be the pressure or any other parameter indicative of the pressure.

The third step of the verification method consists in comparing the measured parameter relating to the pressure against a predetermined expected value.

Specifically, one or more predetermined values are logged, for example in a control unit that controls the verification method, to make it possible to verify whether the measured value or values are consistent with the expected values. For example, if there is a desire to verify that the above-mentioned pressurization has indeed occurred, it is possible to pressurize the segment of the fluid distribution circuit 8 that is situated between the pump 6 and the distribution block 10 (by operating the pump 6 for a duration long enough to theoretically achieve a maximum pressure), to measure the pressure achieved and to compare it against a predetermined expected value that is the maximum pressure expected in the segment.

The fourth step consists in determining an operating status of the cleaning device. Specifically, a difference in value could point to the conclusion that a leak in the system or else a malfunctioning of the pump is preventing the cleaning device from operating properly, and this could, for example, allow it to be switched into a downgraded mode and allow the user of the vehicle to be alerted.

FIG. 2 illustrates two normal modes of operation of the cleaning device 2. This is the measurement of pressure (ordinate axis) as a function of time (abscissa axis) showing the times for which the pump 6 is or is not activated and the times for which the valve or valves 12 is or are closed and open.

Embodiments of the invention in which the parameter measured is a pressure will now be described.

The first portion 18 corresponds, in both curves, to activation of the pump 6, for example when the vehicle is started or when a cleaning cycle is needed, with the valve or valves 12 closed in order to pressurize the segment situated between the pump 6 and the distribution block 10.

That, in theory, makes it possible to achieve a pressure, for example denoted “Pclosed”, which may be the maximum pressure of the segment or any other pressure corresponding to a time of activation of a pump that has a given output.

The two curves thereafter comprise a portion 20 corresponding to a stopping of the pump or to an opening of at least one valve 12 for cleaning for a determined duration, causing the pressure in the segment situated between the pump 6 and the distribution block 10 to drop. It will be noted here that it is possible for a residual pressure, for example denoted “Prest”, to remain in the segment situated between the pump 6 and the distribution block 10.

The right-hand curve comprises two other portions 22 and 24 respectively corresponding to closure of the open valve or valves 12 with a pump 6 running and therefore to a new increase in the pressure in the segment situated between the pump 6 and the distribution block 10 (for example until the pressure Pclosed is achieved once again), followed for example by a stopping of the pump which, like with the portion 20, leads to a drop in pressure in the segment situated between the pump 6 and the distribution block 10. Here again, a residual pressure may remain in the segment situated between the pump 6 and the distribution block 10.

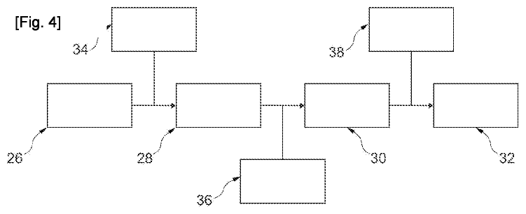

FIG. 3 on the other hand illustrates three defective modes of operation of the cleaning device 2. As in FIG. 2, this shows the measurement of pressure (ordinate axis) as a function of time (abscissa axis) showing the times for which the pump 6 is or is not activated and the times for which the valve or valves 12 is or are closed and open.

On the left-hand curve, a portion 18′ illustrates activation of the pump 6 with the valve or valves 12 closed, for a duration theoretically long enough to allow an expected pressure, for example Pclosed, to be achieved. However, the pressure achieved and illustrated by the portion 18′ is lower than that expected (there could potentially be no increase in pressure at all). The steps of the verification method according to the invention (pressurization, measurement of a parameter which in this instance is the pressure, comparison against a predetermined expected value which in this instance is Pclosed, and determination of an operating status of the cleaning device following this comparison) make it possible to identify a difference between the measured value and the predetermined expected value and thus conclude that the cleaning device is malfunctioning, something which may for example allow it to be switched into a downgraded mode and allow the use of the vehicle to be alerted.

Regarding the fault scenario observed here, this may be a leak, for example due to poor closure or absence of closure of at least one valve 12, or a fault with the pump 6 that does not allow the segment situated between the pump 6 and the distribution block 10 to be correctly pressurized.

The middle curve in FIG. 3 illustrates a second fault scenario.

In this scenario, the portion 18′ coincides with the portion 18 because the pressurization has been satisfactory. However, the portion 20′ may, as in this curve, demonstrate an absence of decrease in the pressure or a decrease in pressure that is slower than expected. As a result, and following the opening of at least one valve 12 for a time of determined duration, the measured pressure is higher than the predetermined expected pressure and a problem is identified following comparison of the two values. In this particular instance, this may be a partial or complete failure to open of the valve or valves 12 that are supposed to be open.

The right-hand curve itself illustrates a third fault scenario.

The portions 18′ and 20′ respectively overlap the portions 18 and 20, testifying to the fact that the operation has been normal up to this point.

However, at the moment of re-closure of the valve or valves 12 which re-closure has led to a drop in pressure (portion 20) with a pump 6 still active for a time of determined duration, it is found that the increase in pressure is slower than expected, as shown by the portion 22′ compared with the portion 22 (there could even be no increase in pressure at all) for the same period of time. A problem is therefore noted, and may here again correspond to poor closure or absence of closure of at least one valve 12, or to a fault with the pump 6 that does not allow the segment situated between the pump 6 and the distribution block 10 to be correctly pressurized.

FIG. 4 shows the various steps illustrated by the curve portions 18, 20, 22 and 24.

The first step 26 corresponds to activation of the pump 6 with the valve or valves 12 closed and therefore to the increase in pressure corresponding to the portion 18. This is followed by a step 28 corresponding to an opening of at least one valve 12 and therefore to a drop in the pressure, as illustrated by the portion 20. Step 30 corresponds to a return of the open valve or valves to the closed state with the pump 6 still active, and therefore to the portion 22 that illustrates a new increase in pressure. Finally, step 32 may correspond to the switching-off of the pump 6 and therefore to a pressure drop illustrated by the portion 24.

Steps 34, 36 and 38 correspond to the three pressure measurements described above, namely:
between steps 26 and 28 in order to verify that a predetermined pressure, for example the maximum pressure, has been achieved,
between steps 28 and 30 in order to verify that there has been a decrease in pressure following the opening of at least one valve 12, and
between steps 30 and 32 in order to verify that there has been a new increase in pressure following the closure of the open valve or valves 12, with the pump 6 still active.

As explained above, and according to one embodiment of the invention, the command to activate the pump is of a duration that allows a maximum pressure to be achieved in the segment of the fluid distribution circuit that is located between the outlet orifice of the pump and the valve, the predetermined expected value corresponding to the maximum pressure. This then is a verification corresponding to the portions 18 and 22 of the curves in FIGS. 2 and 3. As explained above, the pump 6 is activated for a time of determined duration that should make it possible to achieve a pressure of predetermined expected value, in this instance the maximum pressure. Measuring the pressure and then comparing it against the expected value makes it possible, as explained hereinabove, to notice any malfunctioning of the cleaning device.

In a variant, the method steps take place upon the starting of the engine of the motor vehicle. This will preferably be the verification mode corresponding to pressurizing the segment situated between the pump 6 and the distribution block 10. Obviously, the method involving verifications at the time of pressurization may be performed at the time of a cleaning cycle (i.e. the segment situated between the pump 6 and the distribution block 10 may be pressurized before at least one valve 12 is opened). It is also possible, when starting the vehicle, to perform the above-mentioned pressurization and then to measure, as explained above, a decrease in pressure.

The method steps may take place at least once during a cycle of cleaning at least one surface of the motor vehicle so as to measure, at least once, one of the pressures described hereinabove and illustrated in FIGS. 2 and 3, namely to measure a parameter relating to the pressure in the segment of the fluid distribution circuit located between the outlet orifice of the pump and the valve and compare it against a predetermined expected value:
after pressurization and before a first opening of a valve 12,
after opening of at least one of the valves 12 for a period of determined duration so as to measure the decrease in the parameter relating to the pressure and compare it against a predetermined expected value (in which case, the pressure measured in the segment situated between the pump 6 and the distribution block 10 needs to be lower than the pressure prior to the opening of the valve or valves 12),
between two openings of one or more valves 12 (re-pressurization illustrated by the portion 22, or else drop in pressure between two openings of one or more valves 12),
and after the pump 6 has stopped.

The opening of the valve preferably takes place after the pressure in the segment of the fluid distribution circuit located between the outlet orifice of the pump and the valve has reached a maximum value. That makes it possible to create a stage-level making it possible to ensure that the pressure passing through the open valve or valves 12 will be the maximum pressure. It is therefore possible to limit the pressure drops along the length of the fluid distribution circuit 8.

An electronic control unit may be connected to the pressure sensor, to the pump and to the valve so as to control the activation of the pump, the opening and closing of the valve and the measuring of a parameter related to the pressure. This control unit therefore allows control of the various elements enabling a cleaning cycle, but also makes it possible to carry out the method for verifying the operation of the cleaning device.

In addition to taking measurements of a parameter relating to the pressure, it is possible to monitor the flow rate of cleaning liquid in the fluid distribution circuit 8.

To do that, the verification method may comprise, at least once, the following series of steps:
command to activate the pump to inject liquid as far as the valve during a determined time period,
measurement of at least one flow rate of cleaning liquid,
comparison of the measured flow rate against a predetermined expected flow rate, and
determination of an operating status of the cleaning device.

In such a type of verification, the benefit is that it is possible to verify, under determined conditions and at a determined location, that the liquid flow rate is indeed that expected (the four-step principle of operation is the same as that described above).

For example, a flow sensor may be connected to the pump so as to measure the flow rate of liquid leaving the pump.

Alternatively, at least one flow sensor may be present at the distribution block 10 according to one of the following options:
the distribution block comprises a valve, a flow sensor being connected to the valve so as to measure the flow rate of liquid leaving the valve, or
the distribution block comprises several valves, at least one flow sensor being connected to all the valves or to some of the valves so as to measure the flow rate of liquid leaving the valve.

In addition to measuring a parameter relating to the pressure and as an alternative or in addition to measuring a flow rate, it is possible to measure the electrical power consumption of the pump 6 when activated.

Specifically, the current drawn by the pump 6 when running under given (for example temperature) conditions is known. Electrical power consumption values can therefore be determined and logged. This may for example be the electrical power consumption of the pump 6 at the moment of pressurization of the segment of the fluid distribution circuit 8 comprised between the pump 6 and the distribution block 10.

The method may, in that case, comprise, performed at least once, the following steps:
command to activate the pump to inject liquid as far as the valve during a determined time period,
measurement of the electrical power consumption of the pump,
comparison of the electrical power consumption of the pump against a predetermined expected draw of current, and
determination of an operating status of the cleaning device.

This scenario, just as the flow measurement scenario, employs the same type of measurement means (sensor for measuring the electrical power consumption of the pump) and control means (control unit to receive the data, measure, compare against the expected values and determine an operational status of the cleaning device) as those that allow the verifications to be made via a parameter relating to the pressure.

The invention is not limited to the embodiments presented, and further embodiments will be clearly apparent to a person skilled in the art. It is notably possible for the architecture (i.e. the layout of the various means present) of the cleaning device 2 to differ from that described above. It is also possible for the measurements to be taken at different moments from those illustrated in the figures, provided that it is possible to compare the measured values against predetermined expected values.

What is claimed is:

1. A method for verifying the operation of a vehicle-surface cleaning device intended to be mounted on a motor vehicle, the cleaning device comprising a reservoir with cleaning liquid, at least one nozzle for spraying the cleaning liquid onto a surface that is to be cleaned, a fluid distribution circuit designed to convey the cleaning liquid from the reservoir to the cleaning nozzle and a pump designed to inject the cleaning liquid contained in the reservoir into the fluid distribution circuit, the fluid distribution circuit comprising a cleaning fluid distribution block comprising at least one valve and positioned between an outlet orifice of the pump and the nozzle, the method being characterized in that it comprises, at least once, the following steps:
command to activate the pump to inject cleaning fluid as far as the valve during a determined time period, the command to activate the pump to inject liquid as far as an inlet orifice of the valve being coupled with the keeping of the valve or valves in the closed state,
at least one measurement of a parameter relating to the pressure of the cleaning liquid in a segment of the fluid distribution circuit located upstream of the valve or valves using at least one pressure sensor,
comparison of the measured parameter relating to the pressure against a predetermined expected value,
determination of an operating status of the cleaning device on the basis of the result of the comparison between the measured parameter relating to the pressure and the predetermined expected value, and
generation of a warning signal in the event that the cleaning device is malfunctioning.

2. The verification method as claimed in claim 1, wherein the duration between the command to activate the pump while keeping the valve or valves in the closed state is greater than or equal to a duration enabling a maximum pressure to be attained in the segment of the fluid distribution circuit that is located between the outlet orifice of the pump and the valve in normal operation.

3. The verification method as claimed in claim 1, the method steps taking place upon the starting of the engine of the motor vehicle.

4. The verification method as claimed in claim 1, the method steps taking place at least once during a cycle of cleaning at least one surface of the motor vehicle.

5. The verification method as claimed in claim 4, wherein the measuring of the parameter relating to the pressure in the segment of the fluid distribution circuit that is located upstream of the valve or valves takes place prior to the first opening of a valve or between two openings of a valve.

6. The verification method as claimed in claim 1, wherein the command to activate the pump to inject liquid as far as an inlet orifice of the valve is followed by an opening of the valve for the duration of a determined period, the opening of the valve preceding a measurement of the parameter relating to the pressure in the segment of the fluid distribution circuit that is located upstream of the valve or valves.

7. The verification method as claimed in claim 1, wherein the cleaning device further comprises at least a flow sensor, the verification method comprising, at least once, the following steps:
command to activate the pump to inject liquid as far as the valve during a determined time period,
measurement of at least one flow rate of cleaning liquid,
comparison of the measured flow rate against a predetermined expected flow rate, and
determination of an operating status of the cleaning device.

8. The verification method as claimed in claim 7, wherein a flow sensor is connected to the pump so as to measure the flow rate of liquid leaving the pump.

9. The verification method as claimed in claim 7, wherein:
the distribution block comprises a valve, a flow sensor being connected to the valve so as to measure the flow rate of liquid leaving the valve, or
the distribution block comprises several valves, at least one flow sensor being connected to all the valves or to some of the valves so as to measure the flow rate of liquid leaving the valve.

10. The verification method as claimed in claim 1, wherein the cleaning device further comprises a measurement device measuring the electrical power consumption of the pump, the verification method comprising, at least once, the following steps:
command to activate the pump to inject liquid as far as the valve during a determined time period,
measurement of the electrical power consumption of the pump,
comparison of the electrical power consumption of the pump against a predetermined expected draw of current, and
determination of an operating status of the cleaning device.
